(19) United States
(12) Patent Application Publication
(10) Pub. No.: US 2017/0255886 A1
(43) Pub. Date: Sep. 7, 2017

(54) WORKFLOW EXECUTION

(71) Applicant: Hewlett-Packard Development Company, L.P., Houston, TX (US)

(72) Inventors: Adler Schmidt, Porto Alegre (BR); Alessandro Carlos Hunhoff, Porto Alegre (BR); Ricardo Miotto Redin, Porto Alegre (BR); Jair F. Teixeira Dos Santos, Fort Collins, CO (US); Fabio Juliano Feltraco, Porto Alegre (BR); Felipe Moroni Brandalise, Porto Alegre (BR)

(21) Appl. No.: 15/060,091

(22) Filed: Mar. 3, 2016

(51) Int. Cl. G06Q 10/06

(52) U.S. Cl. CPC G06Q 10/0633

(57) ABSTRACT

Example implementations relate to workflow execution. For example, workflow execution may include identifying a plurality of steps of a workflow and a plurality of dependencies corresponding to the plurality of steps, constructing an execution graph for the plurality of workflow steps based on the plurality of dependencies, and executing a plurality of worker executors in a container based on the execution graph, wherein each of the plurality of worker executors are instantiated based on a reference to a worker actor in a bundle registered in a worker repository of the container and wherein each of the plurality of worker executors executes a workflow step of the plurality of workflow steps.

### BACKGROUND

A workflow system may include a system that automates a workflow process. The workflow system may manage the creation, versioning, and execution of portions of the workflow process. A workflow system may be used over and over again to develop and accomplish varied workflows.

### BRIEF DESCRIPTION OF THE DRAWINGS

FIG. 1 illustrates an example of an environment for implementing a workflow execution system.

FIG. 2 illustrates a diagram of an example of a system of workflow execution.

FIG. 3 is a block diagram depicting an example of a machine-readable storage medium comprising instructions executable by a processor to implement a system of workflow execution.

FIG. 4 is a flow diagram depicting an example of a method of workflow execution.

### DETAILED DESCRIPTION

A workflow system may orchestrate an automation of workflow development, versioning, and execution within an enterprise. The workflow system may automate a workflow process in a generic and reusable fashion.

The workflow systems may be constructed over and over again to satisfy minor parameter demands of a specific project. For example, multiple workflow system engines may be developed and utilized in house to accomplish various workflows in a manner that meets minor parameter demands. For example, distinct workflow systems may be utilized to accomplish various workflows within various cloud or server hosting restrictions, to enable various operations that the workflow supports, to achieve various overall system performance metrics, and/or to achieve extensibility of new operations.

In order to achieve the various parameter demands associated with the various workflows, workflow systems and/or their components are constructed over and over again. That is, the demand for a workflow system to meet a variety of parameters is presently met with repeatedly developing and utilizing a variety of workflow execution systems. Reworking and reproducing a workflow system may introduce unnecessary costs to an enterprise, especially where the reworking includes reproducing a component of the workflow system that has already been produced in a different iteration of a workflow system within the enterprise. For example, time and computational resources of an enterprise may be consumed in unnecessarily reworking and recreating the same components of a workflow system over and over again due to some minor parameter difference that other solutions don't yet meet.

In contrast, a workflow execution system that provides generic versioning and execution of workflows is described herein. The workflow execution system may also be able to consistently scale out, support a thorough availability with hot deploys and removals, version the workflow execution components for backwards compatibility, foster fault tolerance all within a computing environment. The workflow execution system may include an application development and execution step-based workflow system that utilizes components operable within cloud-based environments. For example, a workflow execution system according to the present disclosure may include identifying a plurality of steps of a workflow and a plurality of variable dependencies corresponding to the plurality of steps. The workflow execution system may construct an execution graph for the plurality of workflow steps based on the plurality of variable dependencies. The workflow execution system may execute a plurality of worker executors in a container based on the execution graph, wherein each of the plurality of worker executors are instantiated based on a reference to a worker actor in a bundle registered in a worker repository of the container, and wherein each of the plurality of worker executors executes a workflow step of the plurality of workflow steps.

For example, the workflow execution system may include a workflow management system. A workflow management system may provide the infrastructure for the set-up, performance, and/or monitoring of a defined sequence of tasks. In an example, the tasks may include business related tasks for an organization. For example, the tasks may include business processes related to payment processing, interactive product catalogue management, automated billing systems, security, content management, IT service management, customer relationship management, resource planning, business intelligence, project management, collaboration, application integration, and forms management tasks. These tasks may be performed through automated services provided by application software workflow engines.

Previously, creation of new versions of the application software workflow engines often involved repeated reconstruction of application software workflow engine components existing in the workflow system to meet minor basic requirements unique to a specific project. However, the workflow execution system described herein may utilize generic versioning technology that supports the creation of applications/application versions by utilizing functionalities separated over modular building blocks. Further, the workflow execution system described herein may utilize a cloud-ready solution for segmentation of the sequence of tasks associated with the workflow. The combination of genericizing functional building blocks and utilizing cloud-friendly task segmentation may allow the workflow execution system to advantageously eliminate duplicative reconstruction associated with creating a same application over and over again due to some minor hardware, software, and/or system requirement that existing applications don't yet meet.

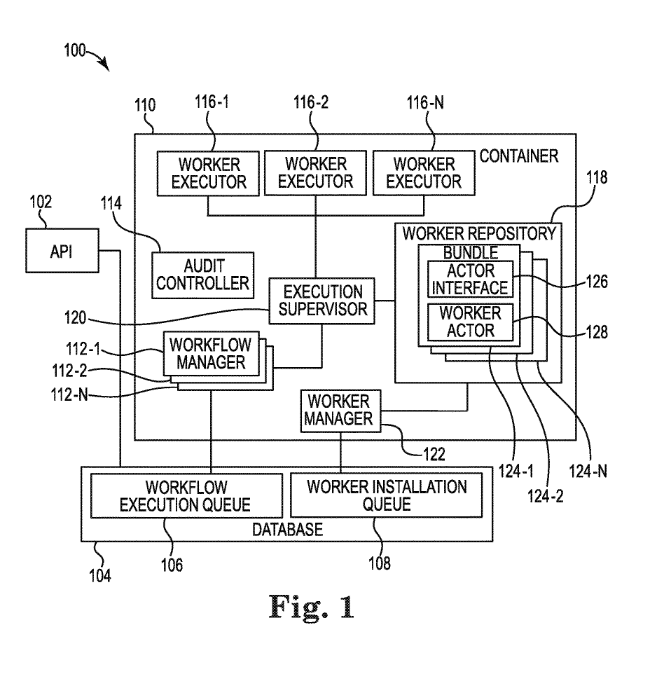

FIG. 1 illustrates an example of an environment 100 for workflow versioning and execution for application development. The environment 100 may include an application program interface (API) 102, a database 104, a workflow execution queue 106, a worker installation queue 108, a container 110, a plurality of workflow managers 112-1-112-N, 114 audit controller, a plurality of worker executors 116-1-116-N, a worker repository 118, an execution supervisor 120, a worker manager 122, a plurality of bundles 124-1-124-N, an actor interface 126, and a worker actor 128.

The environment 100 may be a partially or completely cloud-based environment. As used herein, a cloud based environment may include an Internet based computing environment where shared resources, data, and information are provided to computing components and/or other devices on demand. For example, a cloud based environment may include a portion of an Internet based workflow execution application distributed across a number of shared computing resources. The cloud based environment may include a private cloud environment with the cloud comprising computing resources delivered from enterprise computing resources.

The various portions of the environment 100 described herein may be distributed across and/or may utilize computation resources distributed across a server and/or servers of an enterprise. For example, the API 102 may be a World Wide Web accessible enterprise interface and the database 104, workflow execution queue 106, worker installation queue 108, container 110, worker manager 122, worker repository 118, bundle 124-1-124-N, actor interface 126, worker actor 128, workflow manager 112-1-112-N, execution supervisor 120, worker executor 116-1-116-N, and audit controller 114 may be distributed across and/or may utilize computation resources distributed across various enterprise computational resources.

The environment 100 may be accessible via an API 102. The API may be an interface available to a client via the World Wide Web. As used herein, an API 102 may include a set of routines, protocols, and tools for building an application. The API 102 may facilitate an application developer's design, versioning, and execution of applications and associated workflows utilizing portions of the environment 100. The API 102 may function as an interface between a client, such as an application developer, and the database 104, workflow execution queue 106, worker installation queue 108, container 110, worker manager 122, worker repository 118, bundle 124-1-124-N, actor interface 126, worker actor 128, workflow manager 112-1-112-N, execution supervisor 120, worker executor 116-1-116-N, and audit controller 114.

The API 102 may be a representational state transfer API (REST API). As used herein, a REST API may include an architectural style and an approach to communications that is used in the development of applications capable of utilizing cloud-based distributed resources. As opposed to a simple object access protocol (SOAP) that writes or uses provided server programs (to serve data) and a client program (to request data), a REST API may utilize a decoupled architecture with a limited and therefore relatively lighter weight communication scheme for utilizing cloud-based distributed resources. As used herein, a REST API may include the formal constraints of a uniform interface separating clients from server resources of the environment 100, a stateless protocol where the client-server communication is further constrained by no client context being stored on an enterprise server between requests from the client, clients and intermediaries may cached responses, a disconnected client-server system with an uniform interface between the client and server, a layered system where a client cannot determine whether the client is connected directly to the end server or to an intermediary along the way, and, optionally, code on demand where a server can temporarily extend a client by transferring executable logic to a client (e.g., such as Java applets, JavaScript, etc.).

The API 102 may include a plurality of listeners. As used herein, a listener may include a process that receives incoming client connection requests. The listeners may manage the traffic associated with these requests. For example, the listener may receive and manage an action event such as create, read, update, or delete (CRUD) operations on a database 104. For example, the listener may include a hypertext transfer protocol (HTTP) port listener to receive CRUD operations to the database 104. A CRUD operation encompassing a worker management operation may include an operation involving the orchestration of installing, modifying, deleting, and/or otherwise instructing the workers

The CRUD operation may include an operation encompassing a workflow declaration. As used herein, a workflow declaration may include a list of all the functionalities, applications, and/or computing resources invoked by a workflow. As used herein, a workflow may include an automated series of steps to accomplish an application development process. As used herein, a workflow may include a listing of several workflow steps and/or corresponding functionalities, with each step being implemented by a custom made worker, and a declaration of input and/or output variable utilized in each of the steps. As used herein, a worker may include a bundle 124-1-124-N including an actor interface 126 and a worker actor 128. As used herein, any reference to an “actor” may refer to a set of Erlang programming language-based instructions executable within a distributed cloud environment to perform a specific function associated therewith.

The worker may include hardware and/or instructions executable by hardware to implement a specific function. The specific function may be implemented by instantiating a worker executor 116-1-116-N from a reference to a worker actor 128 within a bundle 124-1-124-N. The specific function may be a function, that when implemented, may achieve a portion of a workflow such as a particular step or portion of a step of the workflow.

The CRUD operation received at the API 102 may include an operation encompassing a worker management operation. A worker may include a workflow manager 112-1-112-N, a worker manager 122, an execution supervisor 120, a worker executor 116-116-N, and/or audit controller 114 instantiated by references to a worker actor 128 in a bundle 124-1-124-N. The worker may be instantiated and/or execute as an actor despite being contained within a bundle 124-1-124-N.

The worker may be introduced into the environment 100 and more specifically introduced into a container 110, through the API. The container 110 may include a Web Container that manages requests for workers and/or the worker repository. The container 110 may include a version-based container. The container 110 may include a Web Container that defines how workers such as those instantiated via reference to the bundles 124-1-124-N are deployed in a service platform in a standard way. The container 110 may include a Web Container that manages the lifecycle, mapping, addressing, versioning, and execution of the workers. The container 110 may include an OSGi Web container that defines how components such as OSGi bundles are deployed in an OSGi service platform in a standard way.

A worker, after being registered a worker repository 118 of the container 110, may be a reusable. The worker may be reused by referencing the existing worker and/or functionality in a future CRUD operation request received at the API 102.

The CRUD operation may also include an operation encompassing a workflow execution operation. As used herein, a workflow execution operation may include an operation associated with the execution of a workflow through implementing functionalities of workers.

An API 102 listener may separate requests received from a client into classes corresponding to the type of CRUD operation. For example, a CRUD operation encompassing a workflow declaration may be separated and managed according to a workflow CRUD class specifying protocols for workflow declarations. A CRUD operation encompassing a worker management operation may be separated and managed according to a worker CRUD class specifying protocols for worker management operation. A CRUD operation encompassing a workflow execution operation may be separated and managed according to a workflow execution class specifying protocols for workflow execution operations.

The API 102 may utilize a Play Web format utilizing a model-view-controller (MVC) architectural pattern. The Play Web framework may support HTTP requests and responses with a content type of JavaScript Object Notation (JSON) by utilizing an HTTP API 102 in combination with a JSON library. Accordingly, the API 102 may communicate with a database 104 utilizing a JSON formatting for messaging.

The database 104 may include a collection of resources to store and organize data regarding the workflows, workers, and other environment 100 components. The database 104 may be a NoSQL database. For example, the database 104 may be a NoSQL non-relational database that utilizes JSON-like documents with dynamic schemas. The database 104 may be a NoSQL database as such data structures do not depend on a schema and there is a relatively high heterogeneity of data types and formats to be worked with in interacting with the database 104. The database 104 may utilize a reactive driver that supports non-blocking and asynchronous I/O database operations. The reactive driver may be a plugin based on the Play JSON serialization. Generally, the database may be a NoSQL database that is as generic as possible and that enforces a basic key, valu data structure without relational data enforcement, which might otherwise restrain the versatility of the database 104

The database 104 may include a queue. For example, the database 104 may include a workflow execution queue 106. A workflow execution queue 106 may include a database queue that receives and stores workflow execution data. That is, the workflow execution queue 106 may include a queue for new workflow execution requests including the details of executing each of the steps of the workflow. For example, the workflow execution queue 106 may include data regarding a step and/or steps of the workflow. The workflow execution queue 106 may include data regarding requested execution of the steps of the workflow and/or functionalities implemented in executing each of the steps. The workflow execution queue 106 may include data regarding the dependencies associated with each of the steps. For example, the workflow execution queue 106 may include data regarding input and output variable associated with the execution of each step of the workflow. The workflow execution queue 106 may identify a bundle 124-1-124-N, an actor interface 126, and/or a worker actor 128 associated with executing a step of the workflow and/or the functionality associated with executing a step of the workflow.

The database 104 may include a worker installation queue 108. A worker installation queue 108 may include a database queue that receives and stores a bundle 124-1-124-N, an actor interface 126, and/or a worker actor 128. The bundle 124-1-124-N including the actor interface 126 and/or a worker actor 128 may be created by and received from a client. For example, a client may create the bundle 124-1-124-N by extending a common interface, implement the worker actor 128, reference the actor 128 on the actor interface 126, define input and output dependencies, and send the bundle 124-1-124-N to the API 102. The client may generate the bundle 124-1-124-N as a Java Archive (JAR) package file. The bundle 124-1-124N including the actor interface 126 and worker actor 128 may be communicated to the database 104 and stored in the worker installation queue 108 for eventual registration into the worker repository 118. The bundle 124-1-124-N including the actor interface 126 and/or a worker actor 128 may represent a new bundle 124-1-124-N which implements functionality new to the worker repository 118. The bundle 124-1-124-N including the actor interface 126 and/or a worker actor 128 may represent a new or different version of a bundle 124-1-124-N existing in the worker repository 118.

The container 100 may include a worker manager 122. A worker manager 122 may listen to a corresponding worker installation queue 108 of a database 104. When a new bundle 124-1-124-N is inserted into the worker installation queue 108, for example upon being received from the API 102, the worker manager 122 may detect the insertion and/or identify the new bundle 124-1-124-N for registration into the worker repository 118. The worker manager 122 may perform a registration process of a new bundle 124-1-124-N identified in the worker installation queue 108.

The worker repository 118 may be a repository of bundles 124-1-124-N. The worker repository 118 may be a registry of swappable functional components of a version-based container. For example, the worker repository 118 may include an Open Services Gateway initiative (OSGi) registry. The worker manager 122 may complete the registration process of the bundle 124-1-124-N with the worker repository 118 in OSGi.

The bundles 124-1-124-N in the worker repository 118 may be a swappable set of functional components that may be implemented in various iterations corresponding to various versions of an application. For example, the bundles 124-1-124-N in the worker repository 118 may be OSGi bundles. For example, the bundles 124-1-124-N may be defined by the OSGi specification for modular application development. An OSGi container implementation may allow the breakup of an application into multiple modules such as bundles 124-1-124-N. The OSGi specification may define a set of functionalities or services that a bundle 124-1-124-N may implement and communication protocol between the bundle 124-1-124-N and an application. The bundle 124-1-124-N may include a manifest file including data describing communicational behavior and application version associated with the bundle 124-1-124-N. The bundles 124-1-124-N may be implemented in the environment 100 at any time and, from that point on, can be utilized in the container 110. Developing on an OSGi platform may mean first building an application using an OSGi API 102 and deploying it on an OSGi container 110.

Utilizing the OSGi specifications may allow an install, uninstall, start, and stop of different bundles 124-1-124-N of an application without restarting a container 110. Utilizing the OSGi specifications may permit more than one version of a particular bundle 124-1-124-N at the same time. However, utilizing the OSGi specification has its shortcomings including how an entire system utilizing OSGi bundles may crash if a single OSGi bundle throws a particular exception. These exceptions and/or crashed may be relatively common within an environment 100 utilizing third-party developed software. Moreover, utilizing the OSGi specifications may not consistently operate with some cloud environments and/or scaling out strategies. As such, the bundles 124-1-124-N may not implement workers in a strictly traditional OSGi sense.

As described herein, the bundles 124-1-124-N may also include the actor interface 126 and the worker actor 128 in the bundle 124-1-124-N. A worker actor 128 may be a container for a particular functionality. For example, the worker actor 128 may be instantiated to implement a function corresponding to a step/portion of a step of a workflow. Each bundle of a plurality of bundles 124-1-124-N may include a worker actor 128.

In this manner, a system for executing a workflow may be implemented within the container 110 by utilizing a plurality of modular functions segregated in worker actors 128 of bundles 124-1-124-N. A particular workflow may be executed by picking and choosing which worker actors 128 within which bundles 124-1-124-N to implement in order to execute a unique workflow. In this manner, an array of generic modular workers may exist within a workflow versioning and execution system to be repeatedly implemented in various ways to accomplish different workflows. This may reduce the costs associated with redevelopment of the same or highly similar workers to accomplish a workflow by allowing a client to quickly draw on the resources of the worker repository 118 to implement existing functions without repetitive redesign.

Workers instantiated from worker actors 128 may utilize message-based and asynchronous concurrency. The workers instantiated from worker actors 128 may not share mutable data among themselves and no synchronization primitive may be utilized. The workers instantiated from worker actors 128 may be arranged hierarchically with regard to program failures when executing. Program failures among executing workers instantiated from worker actors 128 may be treated as events handled by a worker's parental supervisor.

A worker actor 128 and the workers instantiated by reference to a worker actor 128 may include Erlang based language instructions that advantageously function in distributed cloud environments. For example, a worker actor 128 may be and/or function like an Akka actor utilizing an Erlang programming language based toolkit for supporting distributed actor-based concurrency. For example, a worker instantiated from reference to a worker actor 128 of a first bundle 124-1 may not share memory with a worker instantiated from reference to a worker actor 128 of a second bundle 124-2. A plurality of workers instantiated from references to worker actors may be executed in parallel. A worker instantiated from reference to a worker actor 128 may offer a fault tolerance feature such as the ability to monitor the status of another worker instantiated from reference to a worker actor 128, fail-over configuration, and automatic recovery. For example, when a worker instantiated from reference to a worker actor 128 is being executed, it may throw an exception. The exception may be directed to another worker instantiated from reference to a worker actor 128 instead of crashing an entire system.

As described above, a bundle 124-1-124-N may include an actor interface 126. The actor interface 126 may include a worker actor activator referring to the worker actor 128 in the same bundle 124-1-124-N. The actor interface 126 may be a wrapper interface that allows a bundle 124-1-124-N, such as an OSGi bundle, to operate, in part, as an actor, such as an Akka actor. The container 110 may therefore implement a system of workflow versioning and execution by workers referencing a plurality of worker actors 128 within swappable version-based container bundles 124-1-124-N, allowing the system workers to operate as actors.

The above described system of workflow versioning and execution within the container 110 may be implemented through the worker manager 122, the worker repository 118, the workflow manager 112-1-112-N, the execution supervisor 120, the audit controller 114, and the worker executor 116-1-116-N. The worker manager 122, the workflow manager 112-1-112-N, the execution supervisor 120, the audit controller 114, and the worker executor 116-1-116-N can comprise individual workers instantiated be reference to corresponding worker actors 128 of corresponding bundles 124-1-124-N. That is, the workflow versioning and execution system may comprise a plurality of worker actors providing modular portions of the versioning and execution functionality of the system. The system may be utilized to develop applications utilizing cloud-based resources.

For each processing core associated with the environment 100, a workflow manager 112-1-112-N may be created in the container 110. The workflow manager 112-1-112-N may monitor the workflow execution queue 106 of the database 104 for new workflow execution requests. When a new workflow execution request is detected, the workflow manager 112-1-112-N may search for a corresponding workflow definition in the database 104. The workflow manager 112-1-112-N may construct an execution graph based on the workflow definition. The workflow manager 112-1-112-N may construct an execution graph mapping the instantiation and/or execution of a plurality of workers referencing worker actors 128 from a corresponding plurality of bundles 124-1-124-N to execute a corresponding plurality of steps of a workflow process.

The execution graph may be based on input and output variables and dependencies associated with each step of a plurality of steps of a workflow. For example, the execution graph may order the execution of a plurality of workers referencing a plurality of worker actors 128 based on the input and output variables and dependencies associated with each step of a plurality of steps of a workflow that correspond to the functionality of each worker actor 128. For example, a particular step and/or portion of a step of a workflow may involve a summing operation. The summing operation may be executed by a worker instantiated by reference to a first worker actor 128 in a first bundle 124-1. Another step and/or portion of a step of a workflow may involve a multiplication operation. The multiplication operation may be executed by a worker instantiated by reference to a second worker actor in a second bundle 124-2. The execution graph may order the instantiation and/or execution of the workers based on the input and output variables and dependencies associated with the two operations.

The order of instantiation and/or execution of the workers determined from the input and output variables and dependencies associated with the workflow steps may include a sequential order of instantiation and/or execution and/or the instantiation and/or execution of a plurality of workers in parallel. Extending the above described example, the workflow manager 112-1-112-N may construct an execution graph ordered such that the worker instantiated by reference to a second worker actor in a second bundle 124-2 that implements the multiplication operation is executed and/or instantiated after the worker instantiated by reference to a first worker actor 128 in a first bundle 124-1 implementing a summing operation. Such an order may result where the multiplication operation of requested in the workflow utilizes the summed output of the summing operation requested in the workflow.

The workflow manager 112-1-112-N may also determine that some workers instantiated by reference to corresponding worker actors may be executed in parallel if the input and output variables and dependencies associated with corresponding workflow steps do not rely on the output other workers. With reference to the above described example. If the multiplication operation and the summing operation are independent insofar as they do not rely on the output and/or input from one another, then the workflow manager 112-1-112-N may construct an execution graph ordering the workers associated with the operations to execution and/or instantiate in parallel.

The workflow manager 112-1-112-N may send the execution graph to an execution supervisor 120. The execution supervisor 120 may manage the instantiation and/or execution of workers instantiated from reference to a corresponding worker actor 128. The execution supervisor may request a reference to each worker actor 128 implementing a function represented in a workflow step. The execution supervisor 120 may request the references to a worker actor 128 from a bundle 124-1-124-N in a worker repository 118.

The execution supervisor 120 may instantiate a worker executor 116-1-116-N corresponding to each reference to a worker actor 128. For example, the execution supervisor 120 may instantiate a particular worker executor 116-1 to execute the functionality associated with a particular referenced worker actor 128. The execution supervision 120 may instantiate the worker executors 116-1-116-N and/or manage the execution of the worker executors 116-1-116-N according to the execution graph. For example, the execution supervisor 120 may instantiate a plurality of worker executors 116-1-116-N in parallel. In an example, the execution supervisor 120 may instantiate a plurality of worker executors 116-1-116-N such that simultaneous execution of the underlying functionality is achieved. Parallel execution of the plurality of workers may be performed by the execution supervisor 120 where the plurality of worker executors 116-1-116-N correspond to workflow steps that do not rely on the output of another worker actor/worker executor.

Alternatively, the execution supervisor 120 may instantiate a plurality of worker executors 116-1-116-N in a sequence as ordered in the execution graph such that worker executors 116-1-116-N that rely on the output of another worker will execute subsequent to the worker upon whose output they depend.

As described above, the workers (e.g., worker executors 116-1-116-N, the execution supervisor 120, the workflow manager 112-1-112-N, and the bundles 124-1-124-N, etc.) may function as actors utilizing concurrency with asynchronous messaging, no shared memory, and various actor architecture fault tolerance measures. The worker executors 116-1-116-N, the execution supervisor 120, the workflow manager 112-1-112-N, and/or the bundles 124-1-124-N may be arranged in a hierarchical manner with respect to error handling. It may be advantageous to refer to the hierarchical arrangement in familial terms. For example, a workflow manager 112-1-112-N may a parent actor in the container 110. The execution supervisor 120 may be a child of the workflow manager 112-1-112-N. A worker executor 116-1-116-N may be a child of the execution supervisor 120 and a grandchild of the workflow manager 112-1-112-N. The workflow manager 112-1-112-N, the execution supervisor 120, and the worker executor 116-1-116-N may be chained together actors. An exception thrown by any of the workers in the chain may be handled through parental supervision (e.g., resolved by an actor preceding the actor from which the exception is thrown in a hierarchical sense).

The container 110 included in the environment 100 may include an audit controller 114. The audit controller 114 may be and/or function as an actor. The audit controller 114 may detect and/or log an error audit message from any worker in the container 110. When an error occurs, the audit controller 114 may manage a system recovery for the environment 100.

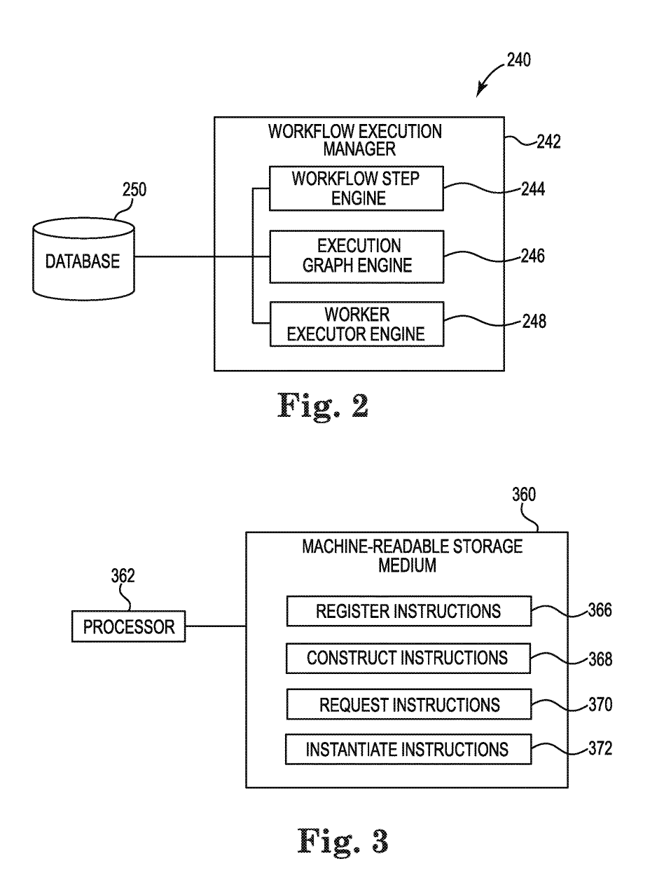

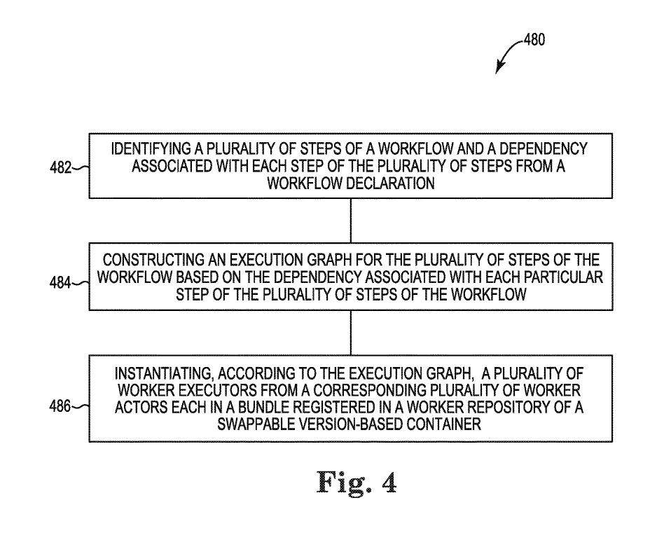

The environment 100 may be an environment suitable for practicing the system described with respect to FIG. 2, execution of the machine readable medium of FIG. 3, and/or practice of the method described with respect to FIG. 4.

FIG. 2 illustrates a diagram of an example workflow execution system 240. The system 240 may include a portion of the environment 100 of FIG. 1. The system may include a database 250, a workflow execution manager 242, and/or an engine and/or a plurality of engines (e.g., a workflow step engine 244, an execution graph engine 246, and a worker executor engine 248, etc.). The workflow execution manager 244 may include additional or fewer engines than those illustrated to perform the various functions as will be described in further detail.

An engine or a plurality of engines (e.g., a workflow step engine 244, an execution graph engine 246, and a worker executor engine 248, etc.) may include a combination of hardware and programming (e.g., instructions executable by the hardware), but at least hardware, that is configured to perform the functions described herein (e.g., identify a plurality of steps of a workflow and a plurality of variable dependencies corresponding to the plurality of steps, construct an execution graph for the plurality of workflow steps based on the plurality of variable dependencies, execute a plurality of worker executors in a container based on the execution graph, etc.). The programming may include program instructions (e.g., software, firmware, microcode, etc.) stored in a memory resource (e.g., computer readable medium, etc.) as well as hard-wired program (e.g., logic).

The workflow step engine 244 may include hardware and/or a combination of hardware and programming, but at least hardware to identify a plurality of steps of a workflow. Identifying a plurality of steps of a workflow may include separating the workflow into functionalities defining distinct workflow steps. Identifying the plurality of steps may include identifying workers to implement the functionalities. Identifying workers to implement the functionalities may include identifying a worker actor in a bundle to reference in instating such a worker. Identifying a plurality of steps of a workflow may include determining portions of a workflow that correspond to modular workers that may be implemented by referencing a worker actor in a bundle stored in a worker repository.

Bundles stored in the worker repository may include a manifest including data describing communication protocols, application verions a worker activator, and/or a dependency associated with the bundle. The bundles stored in the worker repository may include an actor interface referencing a worker actor included therein. In essence, the bundles may be bundles including a wrapper interface that allows the bundle to operate, at least in part, as an actor. The bundle may comprise a modular swappable version based bundle (e.g., an Open Services Gateway Initiative (OSGi) bundle). The worker actor and/or actor interface may comprise an actor including Erlang programming language based instructions developed for distributed cloud environments (e.g., an Akka actor).

The workflow step engine 244 may include hardware and/or a combination of hardware and programming, but at least hardware to identify a plurality of dependencies corresponding to the plurality of steps of the workflow. Identifying the dependencies may include retrieving the dependencies of each step of a workflow from a workflow declaration received at an API. Identifying the dependencies may include identify the inputs and outputs associated with each of step of the workflow. For example, identifying the dependencies may include identifying if a first step of a workflow is dependent on an output of a second step of a workflow. Identifying the dependencies may also include determining input and output dependencies between the modular workers. For example, identifying the dependencies may include identifying whether a function of a particular worker actor of a particular bundle in a worker repository depends on an input from another worker actor to implement the functionality. Identifying the dependencies may include determining a sequence of inputs and outputs to a plurality of workers to accomplish a plurality of steps of a workflow.

The execution graph engine 246 may include hardware and/or a combination of hardware and programming, but at least hardware to construct an execution graph for the plurality of workflow steps. An execution graph may include instructions regarding an order of execution for a plurality of worker executors corresponding to the workflow steps. The order of the execution of the plurality of worker executors may be based on the plurality of identified dependencies corresponding to the plurality of workflow steps.

The worker executor may be an instantiation of a worker based on a reference to a worker actor in a bundle in the worker repository. The worker executor may function as an actor with regard to asynchronous communication, no shared memory with other workers, and/or parental supervision with regard to handling exceptions.

Basing the order of the execution of the plurality of worker executors on the plurality of identified dependencies corresponding to the plurality of workflow steps may include ordering the execution of the plurality of worker executions to be sequential and/or parallel. For example, if a portion of the worker executors do not depend on the output from other worker executors and/or on the output of each other, then that portion of worker executors may be executed substantially in parallel. In another example, if a portion of the worker executors do depend on the output from other worker executors and/or on the output of each other, then the portion of the worker executors may be executed in a sequence that allows for the provision of the outputs before an execution that utilizes them.

A worker executor engine 248 may include hardware and/or a combination of hardware and programming, but at least hardware to execute a plurality of workflow executors in a container based on the execution graph. For example, the worker executor engine 248 may include hardware and/or a combination of hardware and programming, but at least hardware to instantiate and/or execute a worker executor in an order communicated by the execution graph. This may include instantiating and/or executing a portion of a plurality of worker executors simultaneously and/or executing a portion of the plurality of executors sequentially to satisfy dependencies associated therewith. The container may include an swappable version-based container with worker executors behaving as an actor including Erlang programming language based instructions developed for distributed cloud environments (e.g., an Akka actor).

As described above, each of the plurality of worker executors being executed may be instantiated based on a reference to a worker actor. The worker actor may be in a bundle registered in a worker repository of the container. Each of the worker executors may, upon execution, implement a function corresponding to a workflow step of a plurality of workflow steps. That is, each worker executor may implement a modular function that may be utilized in the partial and/or full performance of a requested workflow.

The worker executor engine 248 may include hardware and/or a combination of hardware and programming, but at least hardware to detect and log an error message from a worker executor. Detecting and logging an error message may include performing a system recovery responsive to determining detecting and logging the error. Performing a system recovery may include correcting the error without crashing a system of worker executors.

FIG. 3 is a block diagram depicting an example machine-readable storage medium 360 comprising instructions executable by a processor 362 for workflow execution. In the foregoing discussion, engines 244-248 were described as combinations of hardware and programming. Engines 244-248 may be implemented in a number of fashions. Referring to FIG. 3, the programming may be processor 362 executable instructions 366, 368, 370, 372 stored on a machine-readable storage medium 360 and the hardware may include a processor 362 for executing those instructions. Thus, machine-readable storage medium 360 may be said to store program instructions or code that, when executed by processor 362, implements a workflow execution system system 240 of FIG. 2.

In FIG. 3, the executable program instructions in machine-readable storage medium 360 are depicted as register instructions 366, construct instructions 368, request instructions 370, and instantiate instructions 372. Instructions 366-372 represent program instructions that, when executed, cause processor 362 to implement engines 244-248.

Machine-readable storage medium 360 may include be any electronic, magnetic, optical, or other physical storage device that contains or stores executable instructions. In some implementations, machine-readable storage medium 360 may be a non-transitory storage medium, where the term “non-transitory” does not encompass transitory propagating signals. Machine-readable storage medium 360 may be implemented in a single device or distributed across devices. Likewise, processor 362 may represent any number of processors capable of executing instructions stored by machine-readable storage medium 360. Processor 362 may be integrated in a single device or distributed across devices. Further, machine-readable storage medium 360 may be fully or partially integrated in the same device as processor 362, or it may be separate but accessible to that device and processor 362.

In one example, the program instructions may be part of an installation package that when installed can be executed by processor 362 to implement workflow execution system 240. In this case, machine-readable storage medium 360 may be a portable medium such as a floppy disk, CD, DVD, or flash drive or a memory maintained by a server from which the installation package can be downloaded and installed. In another example, the program instructions may be part of an application or applications already installed. Here, machine-readable storage medium 360 may include a hard disk, optical disk, tapes, solid state drives, RAM, ROM, EEPROM, or the like.

Processor 362 may be at least one central processing unit (CPU), microprocessor, and/or other hardware device suitable for retrieval and execution of instructions stored in machine-readable storage medium 360. Processor 362 may fetch, decode, and execute program instructions 366, 368, 370, and 372, and/or other instructions. As an alternative or in addition to retrieving and executing instructions, processor 362 may include at least one electronic circuit comprising a number of electronic components for performing the functionality of at least one of instructions 366, 368, 370, and 372, and/or other instructions.

Register instructions 366 may, when executed, cause processor 362 to register a bundle in a worker repository. The bundle may include a manifest file, a worker actor that provides a first modular functionality when instantiated, and an actor interface referencing the worker actor. The bundle may be a Java Archive (JAR) file received via an API. For example, the bundle may be a .JAR file received at a hypertext transfer protocol (HTTP) representational state transfer application program interface (Rest API).

The bundle may be registered into a worker repository in a container responsive to detecting the bundle in a worker installation queue of a database. For example, the bundle may be received via an API and saved into a worker installation queue of a non-relational NoSQL database. Once a bundle is registered into the worker repository, the bundle may remain in the repository and/or an accessible database to be made available for utilization in a future workflow. For example, a future workflow request may instantiate a worker executor from a reference to an existing worker actor of an existing bundle registered in the work repository.

Construct instructions 368 may, when executed, cause processor 362 to construct an execution graph. The execution graph may include instructions regarding an order of execution of a plurality of steps of a workflow. The execution graph may be based on dependencies associated with each of the plurality of workflow steps. For example, the execution graph may order an execution of a plurality of workers that will implement a corresponding plurality of functions associated with various steps of a workflow such that a worker implementing a function associated with a step utilizing an output associated with execution of another worker implementing a function associated with another step will be executed subsequent to the another step. Alternatively, the execution graph may order an execution of a plurality of workers that will implement a corresponding plurality of functions associated with various steps of a workflow such execution occurs in parallel for steps not utilizing the output of other steps. Each particular step of the plurality of steps may be associated with a modular functionality. That is, a particular step may request or utilize a functionality to complete its execution. For example, a step of a workflow may utilize a summing functionality to complete the step. This functionality may correspond to a functionality executed by a worker instantiated by reference to a worker actor. In this manner, the worker and/or worker actor may provide a modular functionality to execute a step. Therefore, a step may be associated with a modular functionality where the step may be accomplished by a worker instantiated by references to a worker actor that can implement the functionality to complete the step.

Request instructions 370 may, when executed, cause processor 362 to request a reference to a worker actor in a worker repository. The request may be a request to a reference of a worker actor in a bundle registered in a worker repository of a container. The request to a reference may be utilized to instantiate a worker executor based on the worker actor reference. Since the worker executor may execute a function to perform a step of the workflow, the reference request may be to a worker actor capable of implementing a function of a step of the workflow.

Instantiate instructions 372 may, when executed, cause processor 362 to instantiate a worker executor. The worker executor may be instantiated based on a reference to a worker actor. The instantiation may be performed based on the execution graph. For example, the instantiation may be performed in an order relative to other instantiations of other worker executors informed by the execution graph. The worker executor may execute a function for performing a step of the workflow.

FIG. 4 is a flow diagram depicting an example of a method 480 for workflow execution. The various processing blocks and/or data flows depicted in FIG. 4 are described in greater detail herein. The described processing blocks may be accomplished using some or all of the system components described in detail above and, in some implementation, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 480 as illustrated (and described in greater detail below) is meant be an example and, as such, should not be viewed as limiting. Method 480 may be implemented in the form of executable instructions stored on a machine-readable storage medium (e.g., machine-readable storage medium 360, previously described in connection with FIG. 3), and/or in the form of electronic circuitry.

As illustrated at 482, the method 480 may include identifying a plurality of steps of a workflow. Identifying the plurality of steps associated with a workflow may include identifying a dependency associated with each step of the plurality of steps. The plurality of steps of the workflow and/or the plurality of corresponding dependencies may be identified from a workflow declaration. The workflow declaration may be received via and API and specify the workflow, the workflow steps, a function requested to perform each workflow step and/or the dependencies associated with the steps of the workflow.

As illustrated at 484, the method 480 may include constructing an execution graph for the plurality of steps of the workflow. The execution graph may be constructed based on the dependency associated with each particular step of the plurality of steps of the workflow. The execution graph may include an order of execution for each of a plurality of functions corresponding to steps of the workflow. The order may be determined based on which functions rely on the output of other functions to perform a workflow step.

As illustrated at 486, the method 480 may include instantiating a plurality of worker executors. Each of the plurality of worker executors may be instantiated by referencing a corresponding worker actor. A plurality of worker actors may be available to instantiate from. Each of the plurality of worker actors may be in a corresponding swappable version-based container bundle (e.g., Open Services Gateway Initiative (OSGi) bundle) of a plurality of swappable version-based container bundles registered in a worker repository. The worker executors, the worker actors, the bundles, and the worker repository may be in an OSGi container. The plurality of worker executors may be instantiated according to an order included in an execution graph.

Each of the plurality of worker actors may implement a function. The function may be utilized to perform a portion of a particular step of a plurality of steps of the workflow when executed.

Instantiating the worker executors may include instantiating the worker executors such that they behave, at least in part, as actors. For example, instantiating the worker executors may include enforcing message-based and asynchronous concurrency between the plurality of worker executors. Instantiating the plurality of worker executors may include arranging the plurality of workers hierarchically with parental supervision exception handling.

The foregoing disclosure describes a number of example implementations for workflow execution. The disclosed examples may include systems, devices, computer-readable storage media, and methods for workflow execution. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIG. 4 is an example and is not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designators “N”, particularly with respect to reference numerals in the drawings, indicate that a number of the particular feature so designated can be included with examples of the present disclosure. The designators can represent the same or different numbers of the particular features. Further, as used herein, “a” element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

What is claimed:

1. A workflow execution system, comprising:
a workflow step engine to identify a plurality of steps of a workflow and a plurality of dependencies corresponding to the plurality of steps;
an execution graph engine to construct an execution graph for he plurality of workflow steps based on the plurality of dependencies; and
a worker executor engine to execute a plurality of worker executors in a container based on the execution graph, wherein each of the plurality of worker executors are instantiated based on a reference to a worker actor in a bundle registered in a worker repository of the container and wherein each of the plurality of worker executors executes a workflow step of the plurality of workflow steps.

2. The system of claim 1, further comprising the worker executor engine to detect and log an error message from the worker executor and perform a system recovery.

3. The system of claim 1, wherein the bundle comprises a modular swappable version-based functional bundle.

4. The system of claim 1, wherein the worker actor comprises an actor including an Erlang-based instruction set executable in a distributed cloud environment.

5. The system of claim 1, further comprising the worker executor engine to execute the plurality of worker executors in the container in a sequence with a first portion of the plurality of worker executors executing after a second portion of the plurality of worker executors wherein the first portion depends on an output from the second portion.

6. The system of claim 1, further comprising the worker executor engine to execute a portion of the plurality of worker executors in the container in parallel wherein the portion of the plurality of worker executors execute independent of inputs from other worker executors.

7. The system of claim 1, wherein the manifest file comprises metadata including an application version, a worker actor activator, and a dependency associated with the bundle.

8. A non-transitory computer-readable medium containing instructions executable by a processor to cause the processor to:
register a bundle in a worker repository, wherein the first bundle includes a manifest file, a worker actor that provides a modular functionality, and an actor interface referencing the worker actor;
construct an execution graph for a plurality of steps of a workflow based on dependencies of the plurality of steps, wherein a step of the plurality of steps is associated with the modular functionality;
request a reference to the worker actor from the worker repository; and
instantiate a worker executor for the worker actor based on the execution graph.

9. The non-transitory computer-readable medium of claim 8, wherein the first bundle comprises a Java Archive (JAR) file received at a hypertext transfer protocol (HTTP) representational state transfer application program interface (API).

10. The non-transitory computer-readable medium of claim 8, including instructions executable by the processor to register the bundle responsive to detecting the bundle in a worker installation queue of a non-relational NoSQL database enforcing a key, value data structure without a relational data enforcement.

11. The non- transitory computer-readable medium of claim 8, wherein the bundle is made available for reference in a future workflow.

12. A method of workflow execution, comprising:
identifying a plurality of steps of a workflow and a dependency associated with each step of the plurality of steps from a workflow declaration;
constructing an execution graph for the plurality of steps of the workflow based on the dependency associated with each particular step of the plurality of steps of the workflow; and
instantiating, according to the execution graph, a plurality of worker executors from a corresponding plurality of worker actors each in a bundle registered in a worker repository of a swappable version-based container.

13. The method of claim 12, wherein a particular worker actor implements a function to perform a portion of a particular step of the plurality of steps of the workflow when executed.

14. The method of claim 12, wherein instantiating the plurality of worker executors includes enforcing message-based and asynchronous concurrency between the plurality of worker executors.

15. The method of claim 12, wherein instantiating the plurality of workers includes arranging the plurality of workers hierarchically with parental supervision of exception handling and system restoration.
